(19) United States
(12) Patent Application Publication
(10) Pub. No.: US 2009/0248488 A1
(43) Pub. Date: Oct. 1, 2009

(54) Risk assessment forecasting in a supply chain

(75) Inventors: Mitul Shah, Bangalore (IN); Gilbert Kwame Owusu, Ipswich (GB); Mathias Kern, Ipswich (GB); George Anim-Ansah, Ipswich (GB)

Correspondence Address: NIXON & VANDERHYE, PC, 901 NORTH GLEBE ROAD, 11TH FLOOR, ARLINGTON, VA, 22203, US

(73) Assignee: British Telecommunications public limited company, London (GB)

(21) Appl. No.: 12/078,190

(22) Filed: Mar. 27, 2008

(51) Int. Cl. G06F 17/30

(52) U.S. Cl. 705/10

(57) ABSTRACT

A supply chain forecasting system enabling integrated risk assessment and forecasting of the impact of events on a supply chain comprising a processor adapted to receive, process and output data for a forecast, and a user interface adapted to enable a user to input parameters to facilitate processing of a forecast, wherein the user interface provides a user the ability to select an event which is likely to have an impact on an aspect of a supply chain and to view a visual representation of different types of impact over time of an event thereby enabling a user readily to understand the nature of the impact of an event on a supply chain and hence to select the most appropriate type of impact over time for an event.

### FIELD OF THE INVENTION

The invention relates to integration of risk assessment and forecasting in a supply chain such as for services and/or goods, and in particular, but not exclusively to enabling a user to build sensible scenarios especially, but not exclusively, through a suitable user interface with a computer system adapted to determine appropriate risk forecasts.

### BACKGROUND TO THE INVENTION

Best-in-class companies require a responsive and resilient supply chain to withstand against major disruptions occurring in the business environment. Globalization has increased the supply chain complexity. Disruption in one geography can lead to disruption of the entire supply chain. It is imperative now to have comprehensive enterprise-wide risk management practice. While Risk Management practices have matured in finance markets, they still remain in a nascent stage in supply chains.

Supply Chain disruptions are difficult to forecast. Events like natural disaster or 9/11 cannot be predicted by most sophisticated forecasting engines. However, these events have a very low probability of occurrence. Most of the events impacting supply chain planning are planned (adaptive) or unplanned (reactive). Risk coming out of planned interruption (sales promotion, plant shutdown) can be managed by accepting it and monitoring it, while risk of unplanned events can be controlled or mitigated. In each case, it is extremely important to understand the extent to which it could cause the disruption.

No two events are of the same nature. The context changes with the factors of time, geography, product and person. Macro-economic parameters, geo-political conditions, different regulatory environments, culture and strong human involvement provides multiple combinations of the same events to be managed. Organizations are exposed in different business environments and risk assessment has to take into account the local context. More often than not, business managers are aware of the impact of the event through their past experience, however, they find it difficult to apply that knowledge consistently in the planning. Also, with the exit of experienced personnel their knowledge also goes out of the organization. In the absence of a formal risk assessment process, which enables users to assess the probability and impact of events, risk assessment remains gut feel speculation at best. This results in organization either being vulnerable to residual risk (unmitigated risk) or spending far more money on risk hedging and losing opportunities due to an over cautious approach.

Forecasting science provides strong theoretical approaches to capture the impact of demand and supply drivers on the forecast. However, business users find it difficult to understand and interpret these complex models, limiting their potential of providing best analysis through rigor of mathematics and statistics. Complexity of these models also makes it difficult for the users to completely trust and accept the output and at times, even pushes them to make their own decisions. Lack of ownership in formal Forecasting & Demand Planning process can create ripples in an entire supply chain and makes it susceptible. Scientific modelling captures the historical data and derives intelligence from the past patterns. But in the absence of a history of calendarized events, their performance would be compromised. It is impractical to design different models for different geographies and businesses. Moreover, analysis provided by these models is retrospective—looking at the past, while business requires prospective analysis of the events—looking at the future, with the capability of running “what-if” scenarios for different combinations.

Risk analysis carried out in isolation to the capacity view, will not yield any conclusive results. Hence, it is important to consider events, which not only impacts the demand but also the supply conditions. In modelling environment, this poses further challenges and increases the complexity.

US 2007/0208600A1 for example provides a computerised system for pre-emptive operational risk management and risk discovery and even to forecast the nature of these risks over time in future, but the methodology remains quite constrained and inapplicable for practical implementation in a supply chain. In particular this prior art document does not teach scenario building, nor does it consider demand or supply scenarios, nor the impact of inter-relationship over time of multiple events for example.

### SUMMARY OF THE INVENTION

An aspect of the invention provides a supply chain forecasting system enabling integrated risk assessment and forecasting of the impact of events on a supply chain comprising a processor adapted to receive, process and output data for a forecast, and a user interface adapted to enable a user to input parameters to facilitate processing of a forecast, wherein the user interface provides a user the ability to select an event which is likely to have an impact on a supply chain and to view a visual representation of different types of impact over time of an event thereby enabling a user readily to understand the nature of the impact of an event on a supply chain and hence to select the most appropriate type of impact over time for an event.

Beneficially a user such as a local manager involved in operating a supply chain can interact intuitively with the forecasting system using knowledge of a type of event which is likely to arise and the nature of that event and hence its impact over time for the local supply chain.

In a global business environment, organizations are impacted by a number of events in the external environment. To cope with the risk due to such events and to mitigate the impact of it, it is imperative to have true assessment of risk organizations are posed with. An empirical approach is used here, which captures the experience and local environmental understanding of the planner, different probabilities of the event occurrence with different magnitude stretching for different time durations, and provides aggregated picture through a Risk Index.

After carefully assessing the challenges in designing and implementing statistically rigorous models, an effective and implementable approach has been designed and described here. The primary benefits of the system are—

1. Risk assessment process is easy to interpret for the users.

2. The local environment context and the experience of planners (bootstrapping) is captured and hence, provide consistency in decision making.

3. The framework takes into account
The probability of the events occurring
Time duration of the event
Recurrence of the event within the planning horizon
Impact on demand (positive or negative)
Magnitude of the impact
Combined impact on the forecast.

4. The system also takes into account, both demand and capacity views.

5. Classification of events is based on Impact and Probability to apply correct risk management practice.

A Risk Assessment framework is used as a compliment to the statistical forecasting engine, in stead of a substitute. Sophisticated time series models captures pattern in historical data and generates the base forecast. Changes in business environment and macro-economic factors happen over a long period of time. Impact of these changes can be captured by statistical models as they span over longer time. However, events which are unexpected or impacts the planning horizon in short term, cannot be captured by such models. The Risk Assessment Framework, hence, focuses on impacts of the events for which historical pattern is not available. We could enhance the base forecast accuracy by integrating this simulated risk assessment approach with the statistical forecast using ‘what if’ scenarios. Users can apply their own understanding and experience in generating simulation scenarios, and the output could be used in meaningfully modifying the base forecast. This also enables users to understand the individual and cumulative impact of various events on the planning. A further aspect of the invention provides a supply chain forecasting system enabling integrated risk assessment and forecasting of impact of events on a supply chain comprising a processor adapted to receive process and output data for a forecast and a user interface adapted to enable a user to input parameters to facilitate processing of a forecast, the system comprising a catalogue of pre-defined events which might be influential in the forecast, each event having associated settings for at least one of risk profile, impact, probability, and impact versus time characteristics.

A yet further aspect of the invention provides a supply chain forecasting system enabling integrated risk assessment and forecasting of impact of events on a supply chain comprising a processor adapted to receive process and output data for a forecast and a user interface adapted to enable a user to input parameters to facilitate processing of a forecast, the system being adapted to provide a user interface which enables a user separately to select events according to their likelihood of impact on one of the demand side and the supply side of a supply chain.

Another aspect of the invention provides a supply chain forecasting system enabling integrated risk assessment and forecasting of the impact of events ion a supply chain comprising a processor adapted to receive, process and output data for a forecast, and a user interface adapted to enable a user to input parameters to facilitate processing of a forecast, wherein the user interface provides a user the ability to select an events which is likely to have an impact on an aspect of a supply chain and to create a scenario comprising a number of such events wherein the processor is adapted to combine the effects of the events selected for a scenario in order to determine an overall impact of the events in a forecast, the combination of impacts being weighted according to a predetermined conversion of the sum of the impact values (risk indices) for the individual events.

Another aspect of the invention provides a method of providing an integrated risk assessment and forecast of the impact of events on a supply chain comprising the steps of cataloguing events having a potential impact on a supply chain, enabling a user to build a scenario of selected events, analysing the risk and impact of the events in the scenario, and integrating risk over time of the events to provide a forecast of the behaviour of the supply chain in the scenario.

Further aspects of the invention includes methods of creating supply chain forecasts comprising certain of the steps set out in the following description and as defined in the appended claims. Moreover, further aspects include computer program products comprising instructional data which when implemented by a computer system enable the methods according to the invention, and a yet further aspect includes user interfaces comprising a visual display to enable a user to create a supply chain forecast. These aspects, steps and features of the invention are apparent from the following description of an embodiment of the invention and the appended definitions of the invention set out in the claims. Moreover it should be realised that each feature or step of the invention is combinable in any combination with any other step, steps, feature or features of the invention thereby beneficially to provide novel combinations according to the invention.

### BRIEF DESCRIPTION OF THE DRAWINGS

An embodiment of the invention will now be described by way of example only with reference to the following drawings, in which:

FIG. 1 is a schematic block diagram of a system according to the invention comprising a local computer system networked with other devices;

FIG. 2 is a schematic flow diagram of the process according to the invention as described below;

FIG. 3 is a representative view of a user interface display panel for use in part of the process according to the invention;

FIG. 4 is a schematic view of a second display panel forming part of the process according to the invention;

FIG. 5 is a table of events having certain pre-assigned characteristics;

FIGS. 6A-6F provide a series of representative views of the impact of an event versus time as selectable by a user;

FIGS. 7A-7E, 8A-8E, 9A-9E and 10A-10E respectively comprise four worked examples of impact characteristics versus time and graph of the impact versus time function of impact.

FIGS. 11A-11L provide a series of tables comprising table of risk for a series of eight types of events, four events having an inflationary effect on demand and each of four further events having a deflationary effect on demand, a sum of these risks and an impact conversion table;

FIG. 12 is a graphical output of the combined effect of the individual risks of the event shown in FIGS. 11A-11D and 11F-11I;

FIG. 13 provides a risk quadrant showing the nature of the events shown in FIG. 12;

FIG. 14 is a theoretical risk quadrant providing characteristics of the type of risk shown in each of the four quadrants;

FIG. 15 is a further theoretical risk quadrant showing the theoretical mitigation strategy for each of the types of risk, and

FIG. 16 is a graphical representation of the combined effect of a base forecast together with the sum of the predicted events of FIG. 12.

### DETAILED DESCRIPTION OF THE INVENTION

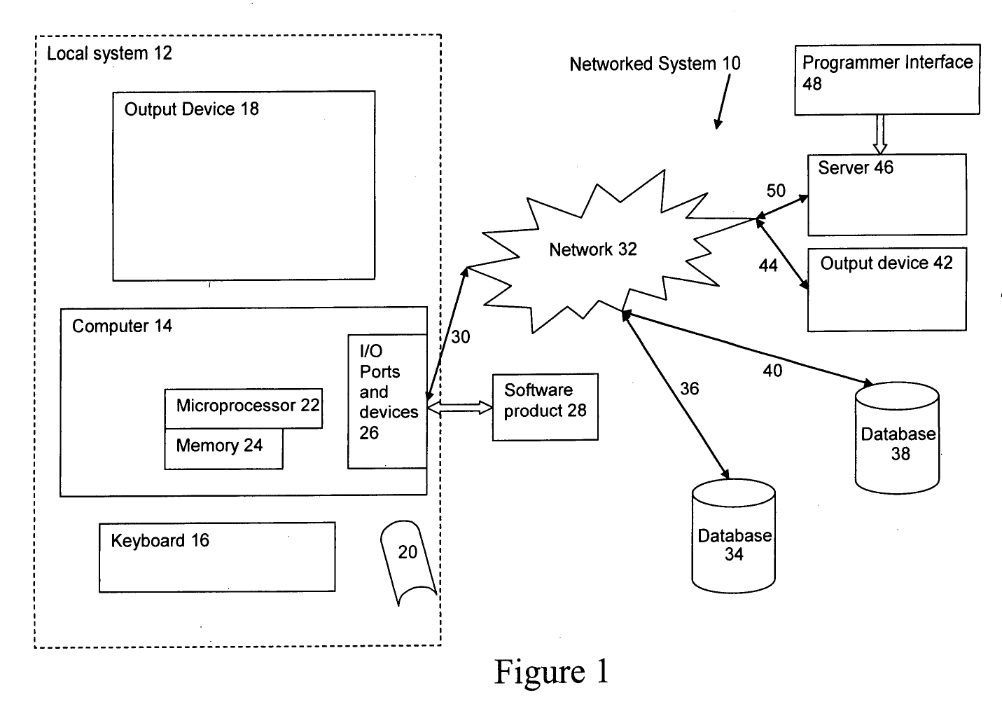

Referring to FIG. 1 there is shown a schematic view of the system 10 according to the invention which is a network of components particularly comprising local computer system 12 comprising a computer 14, such as a well known personal computer manufactured by the likes of IBM or Sony for example, having user input device 16 such as a keyboard, and user output device 18 such as a display or monitor. Computer system 12 further comprises an interactive input device 20 such as a mouse enabling a user to move a curser on display 18 and to select items displayed thereon.

Computer 14 comprises a processor 22, or central processing unit which can be in the form of a microprocessor; a data storage device 24 or memory, which can include a range of devices including volatile and non-volatile storage units including RAM, registers, cache memory and/or mass storage devices such as hard drives.

Accordingly, computer system 12 in particularly comprising display 18, is able to provide a user with a graphical user interface thereby to enable a user to interact with a program running on processor 22.

Computer 14 further comprises input and output ports and devices 26 enabling communication outside the computer system 12 for example through use of a software product 28, such as a CD Rom or other such device e.g. a flash memory, comprising data and/or software code (instructional data) which is insertable in a suitable drive forming part of the input/output 26 of computer 14. Similarly, a suitable output connection is provided between input/output 26 and a network 32. Network 32 might comprise one or more servers, provide a local area network and/or might suitably, for example with appropriate fire walling, enable access of computer system 12 to the internet and/or specific extranet having one or more devices and/or computers. In FIG. 1 there is shown by way of example, the ability of network 32 to link computer system 12 to a local database 34 via connection 36, a remote database 38 via connection 40, a remote output device 42, such as a printer or display via connection 44, and to a remote server 46 having for example an interface 48 to enable a programmer and/or high level user such as a national manager, to interface with server 46 and hence via network 32 with computer system 12.

Here, the processor 22 is a device capable of executing computer programs and in particular of receiving, processing and outputting data for use in integrated risk analysis and forecasting on a supply chain. Such as known processors or central processing units for a computer include microprocessors available from many manufacturers such as an Intel (trademark) and Motorola (trademark). Accordingly processor 22 is suitably programmed or programmable to enable the risk analysis and forecasting process described herein to be performed.

The user interface comprises sufficient elements or devices to enable a user readily to interact with the computer system 12 thereby to interact with the processor 22 and hence to influence the risk assessment and forecasting process, including the input, processing and output of data in that process. Such electronic devices can comprise output devices including a visual output such as a display, and or a printer, and an audio output such as a speaker; input devices such as a keyboard and or a mouse; and/or an interactive display such as a inductive touch screen display. This list is not exhaustive.

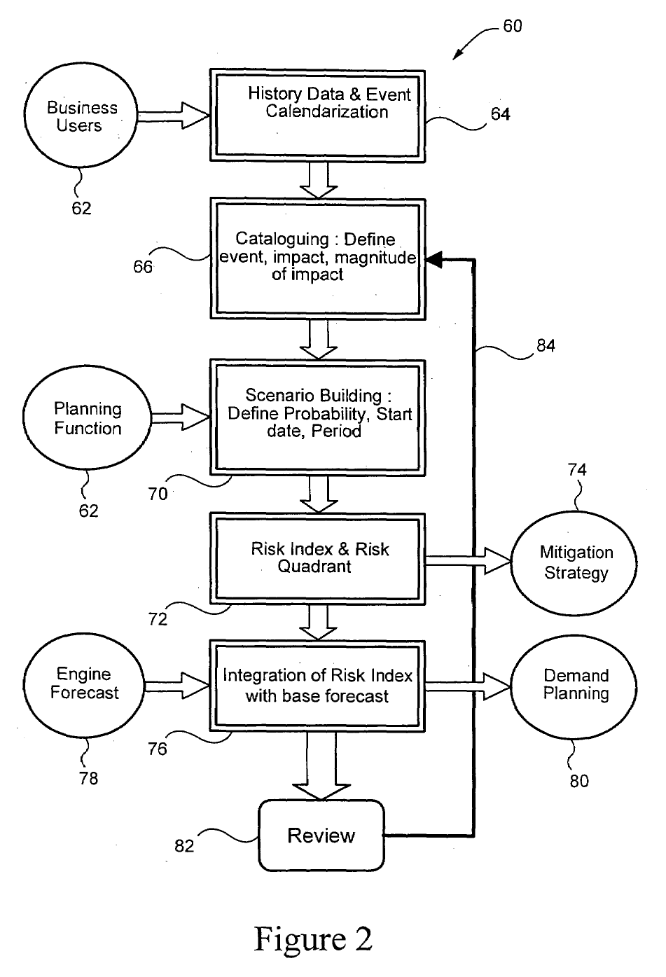

Referring to FIG. 2 showing a schematic flow diagram of the process, as described in greater detail below, of enabling risk assessment and integrated forecasting in a supply chain. The process 60 comprises the ability of a business user 62 to create and/or modify a core computer program and at step 64 to create history data and event calenderisation, thereby to form base data usable for example by a server 46 to create a base forecast of supply chain behaviour for a national supply chain. This can be created by a suitable business user using programmer interface 48 to interact with server 46 shown in FIG. 1 for example.

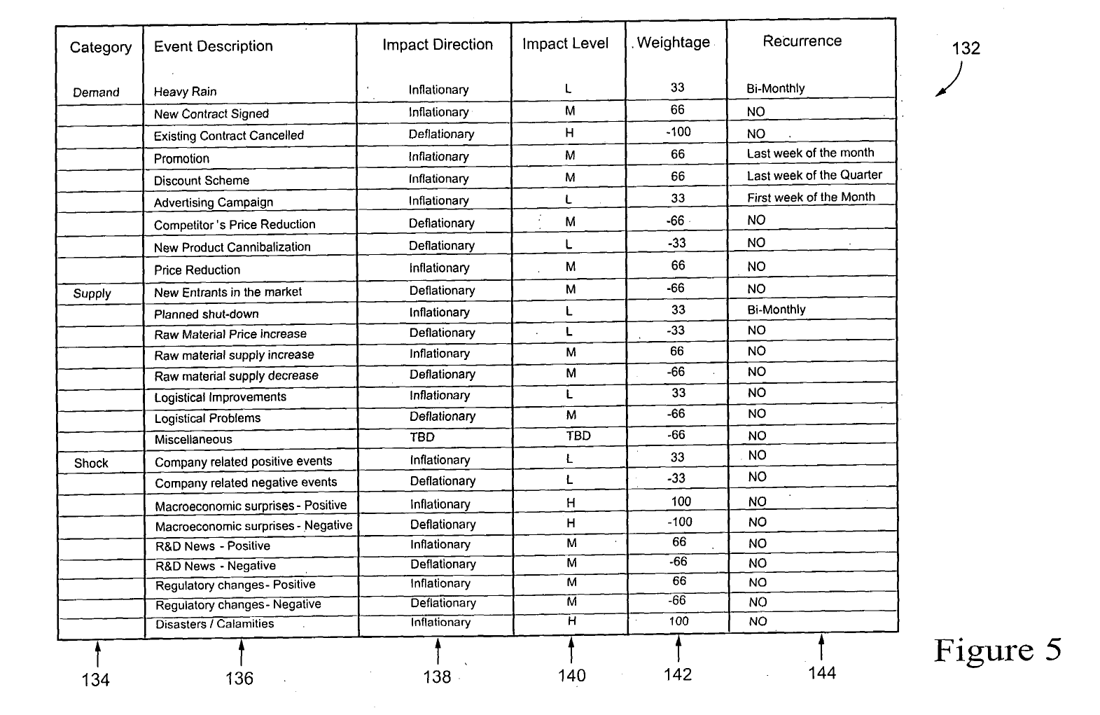

The process 60 further comprises the steps of cataloguing of defined events, their impact, magnitude of impact and other characteristics as shown at step 66. An example of such a catalogue is shown in FIG. 5 as described later.

A user, such as a local manager is able to interface with process 60 as shown at step 68 to effect a local planning function. At step 70 in the process, the user builds a scenario by defining probability, start date and duration periods for events which are likely to impact on a supply chain. At step 72, the computer system 10 and in particular local computer system 12 is able to determine risk index and quadrant information (as described later) and to output this to the user as shown at step 74 thereby to enable a user to create mitigation strategies. At step 76, of process 60, the risk index can be integrated with a base forecast using an engine forecast 78 thereby to provide an output at step 82 for review by a user. The output can be reviewed at step 80 for demand planning and/or to iterate the process to better refine the risk assessment and forecast of impact on a supply chain as shown by the return at step 84 to the cataloguing step 66.

In order to achieve process 60 described in relation to FIG. 2, beneficially computer system 12 provides a user with a display panel 90 displayable on display 18 to enable a user to create a scenario.

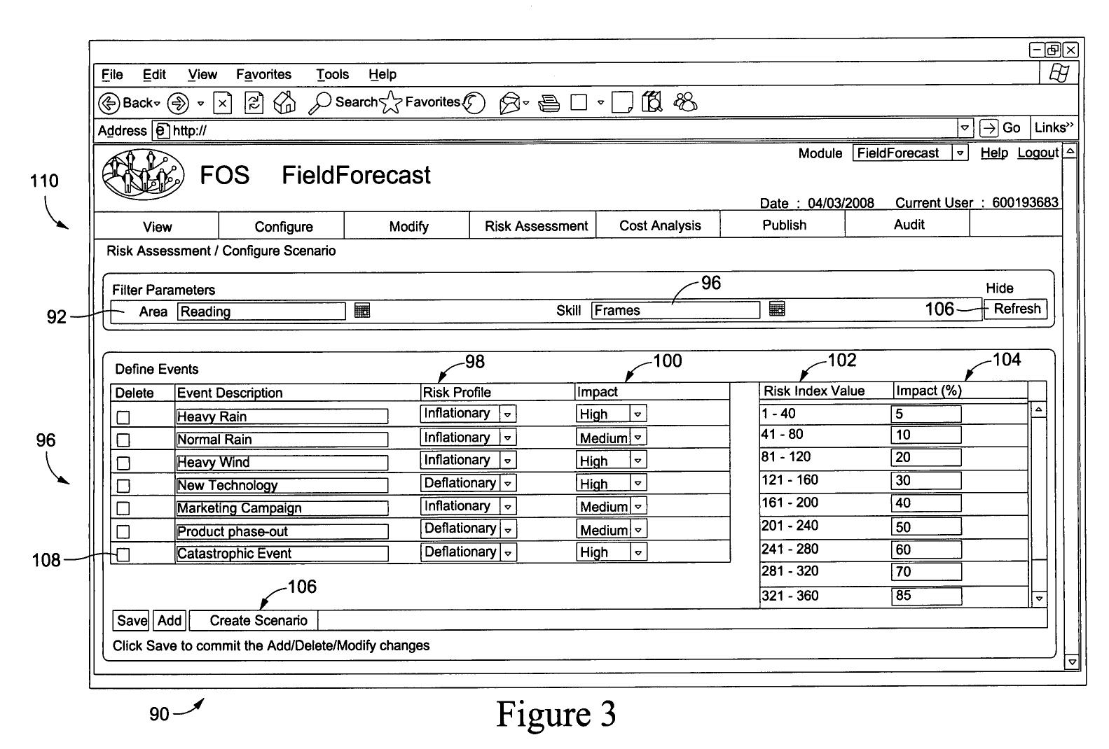

Referring to FIG. 3, the display panel 90 captures a particular step in the process of risk assessment and forecasting according to the invention wherein a user has selected two filter parameters, here first filter parameter 92 being area, the user having selected the town of Reading as shown in FIG. 3, and a second filter parameter 94 here being a skill (a type of service or goods in the supply chain) which here is frames; this being a known representation for a user of a type of service or skill such as here the skill of maintaining frameworks of computers in different locations within a selected area. Beneficially, panel 90 presents the user with a pre-selected range of events 96 based on the first and second filter parameters. Here, seven events are shown, namely heavy rain, normal rain, heavy wind, new technology, marketing campaign, product phase-out, and catastrophic event. A different number and/or different types of event can be provided beneficially based on the first and/or second and/or further filter parameters (as discussed above) or selectable by the user.

Beneficially, each event has certain default characteristics as shown in FIG. 5, in particular risk profile being either inflationary or deflationary (shown as impact direction in FIG. 5), impact level, here being shown as one of high, medium or low (but other levels are definable within the system), weightage (or weight) here being defined as between −100 and +100, and recurrence being definable against a number of criteria such as bimonthly, last week of the month, last week of the quarter and so on.

Impact Weights are beneficially expressed in ordinary language terms but have associated mathematical values such as a percentage or value within a predefined range such as: High—100, Medium—66, Low—33. These weights are positive for inflationary events and negative for deflationary events. If a user thinks an event will have no impact it can simply be deselected from the scenario. The quantitative weight value attached to “High”, “Medium”, “Low” can be changed as required. Ideally, these values should be defined by historical analysis to see the impact of some of the events on demand. Additionally it is possible to use linear (1,2,3 or 2,4,6 or 33,66,100 etc.) or geometrical (1,3,9 or 2,8,64 etc.) or any other relationship, which can best describe the difference between “High” and “medium” and “low” impact.

In one version, display panel 90 automatically displays events selectable from one of three categories one of demand impact, supply impact or shock. Accordingly, the user is able to define impact direction (see FIG. 5) for each event according to its impact on category and hence to consider similar events and/or impacts at the same time. This is not however a case for shock events which can comprise events which have primary impact on the supply side (capacity) and/or demand side of the supply chain. Nevertheless, shock events can be displayed contemporaneously on the same panel for a user to consider the likelihood of impact and/or other characteristics.

Referring to FIG. 5, for Demand Events the relationship of impact on demand is directly proportional, for Supply Events the relationship of impact on supply is inversely proportional to demand (under development process for the demo), and for Shock Events the relationship of impact is directly proportional to either demand or supply. Beneficially however, panel 90 enables a user to modify the default characteristics and for example the risk profile 98 shown on display panel 90 can be modified using a drop down menu to change the risk profile from inflationary to deflationary. This intervention through the user interface can be effected using the mouse 20 to manipulate a curser on display 18 in order to interact with display panel 90.

Similarly, the default impact characteristic 100 can be modified by a user via display panel 90.

Further user tool buttons 106 are provided in display panel 90 including the option to save, add (an event), create a scenario, and refresh.

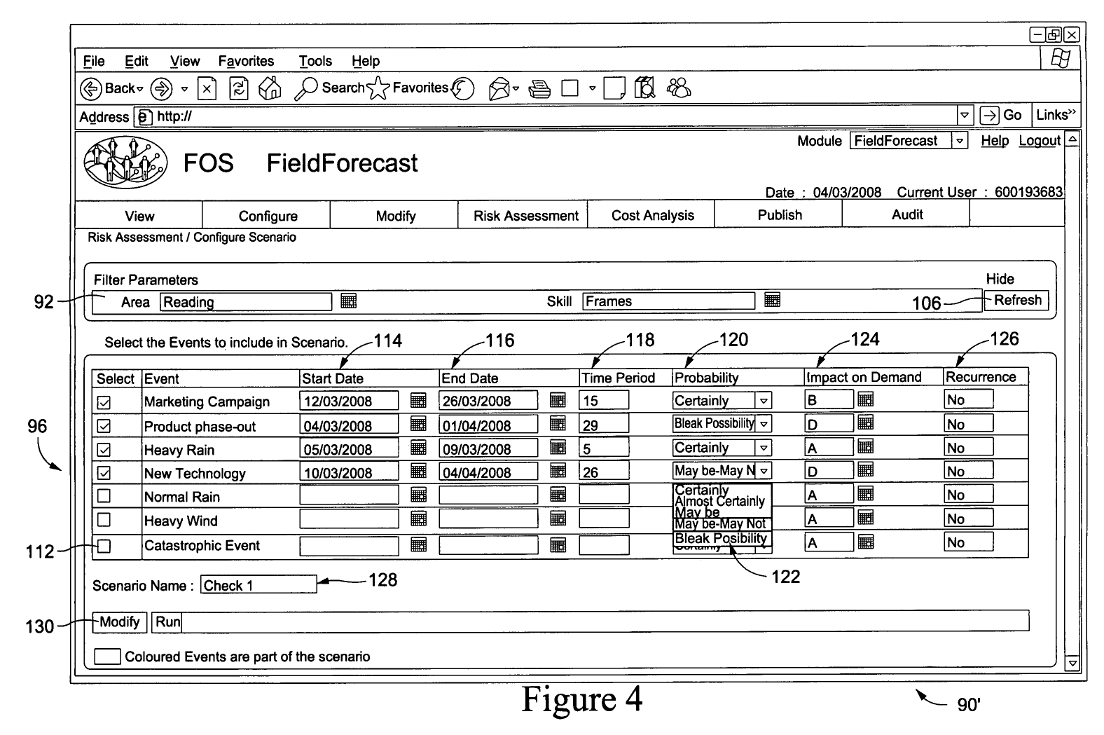

Assuming that a user selects the “create scenario” button 106, then display panel 90 is slightly modified as shown in FIG. 4 wherein the new display panel 90′ prompts the user to input the dates on which a selected event will impact on a supply chain. In the event that a user has not deleted an event (using buttons 108 in display panel 90) the events 96 are displayed in new display panel 90′. Here a user is further prompted positively to select the appropriate events within the scenario as indicated at buttons 112. A start date 114 is inserted by a user against each selected event, either by typing into the appropriate panel in column 114 or using the calendar feature displayed on the adjacent button. The user can input an end date at column 116 in the same manner and/or a time period at column 118, which here is selected in terms of the number of days.

The user is required to select only two of the start date 114, end date 118 and time period 118, and the system automatically then selects the third of the three time characteristics for each event.

A user is able through display panel 90′ to define a probability of recurrence of each event in the scenario, thereby enabling the user to take advantage of any local knowledge under the selected filter parameters and in particular local geographic factors. Referring again to FIG. 4, beneficially the default recurrence properties for an event are also input in column 126 of display panel 90′. Again, the user is able to modify the recurrence based on the local scenario and/or based on filter parameters 92 and 94. The scenario name is shown in box 128. The scenario can be modified or run by operating button 130.

Beneficially, the probability of occurrence of an event is displayed to the user everyday or in easily understandable terms such as certainty, almost certainly, maybe, maybe not, and bleak possibility for example.
Probability inputs
Certainly—1.0
Almost Certainly—0.9
Maybe—0.7
Maybe—Maybe Not—0.5
Bleak Possibility—0.1

The phrases “Certainly”, “Almost certainly” etc. could be change as per business user requirement. Also, the quantitative probability value attached to it. Hence, this remains flexible to suit a typical business requirement.

Accordingly, the local computer system 12 is able to determine based on the input probability 120 of the likely recurrence of an event and hence use this in the risk assessment analysis. A drop down panel 122 is provided in order to help the user to select the most appropriate term under expression of probability based on local experience.

Additionally, a user is able to determine the impact on demand 124 of any event as shown in the column labeled “impact on demand” 124. Beneficially, the impact on demand is labeled with a simple alpha/numeric label and this can form part of a standard characteristic of an event as held in the default parameters (albeit not shown in FIG. 5). However, beneficially the system 12 is adapted easily to enable a user to determine the suitability of impact on demand of the associated event (i.e. that shown in the same row on display panel 90′) through this interface tool.

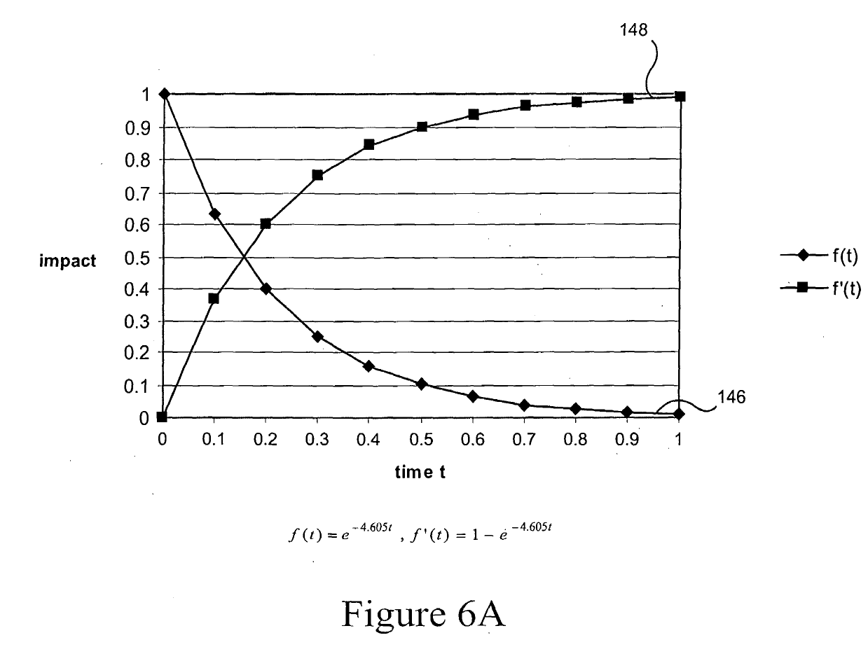

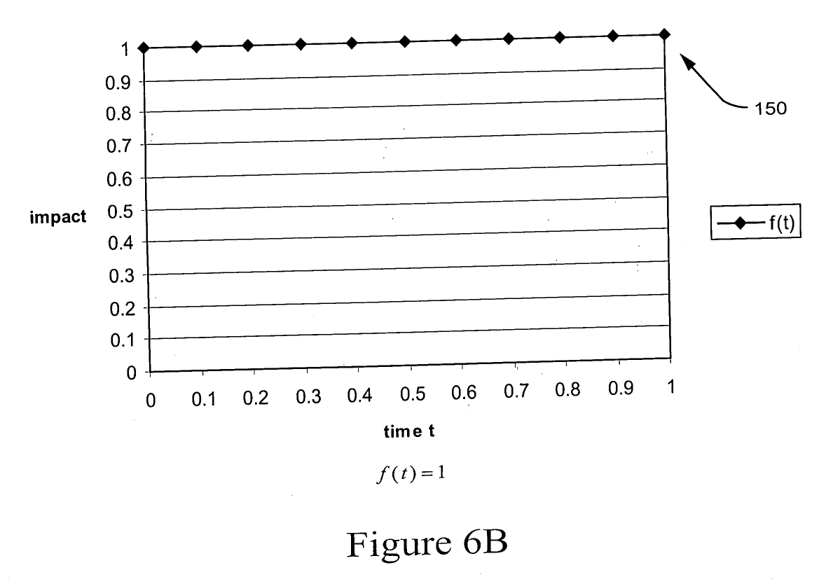

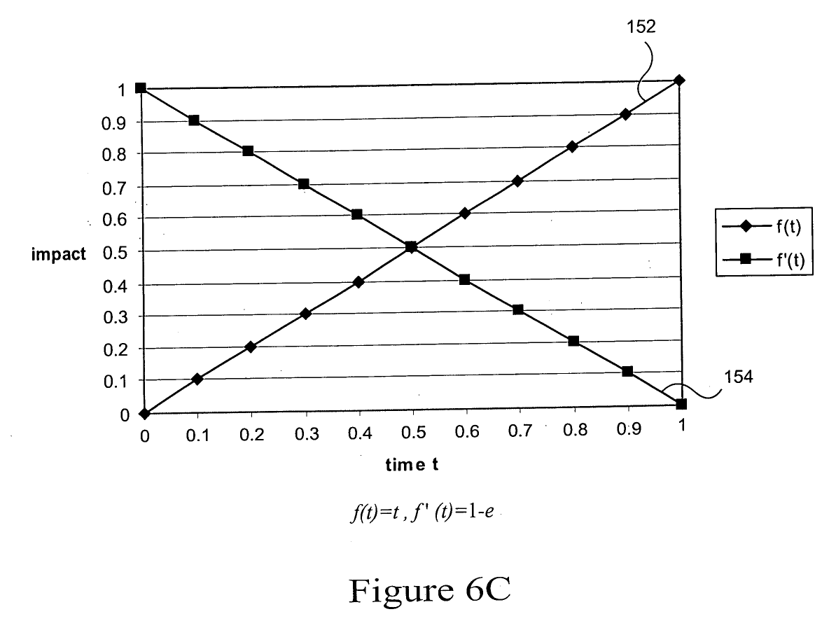

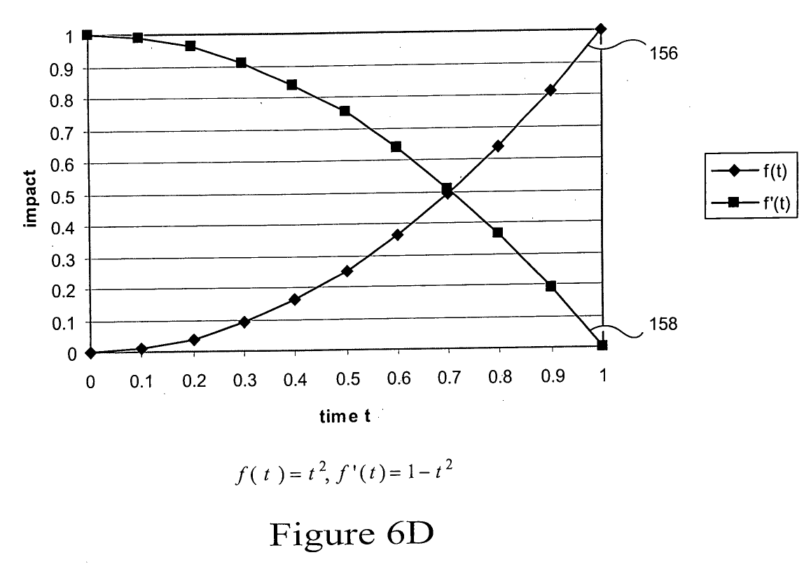

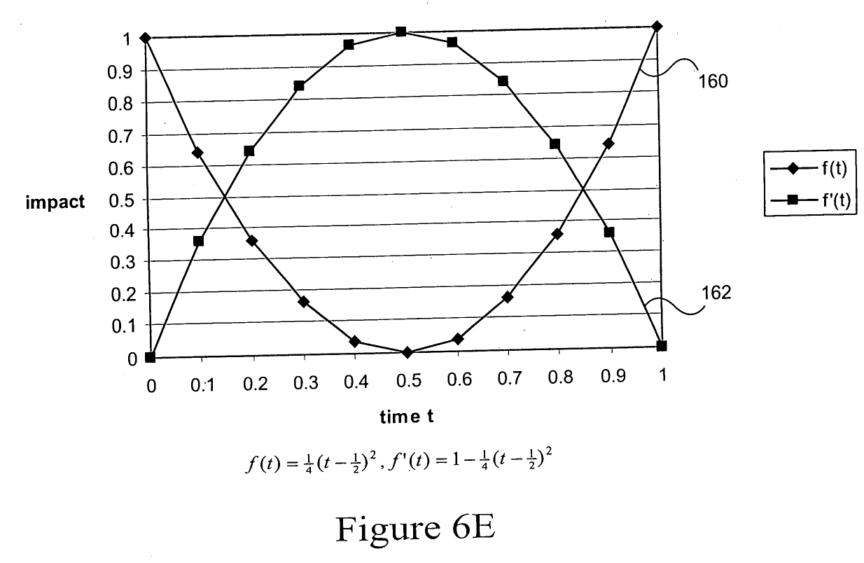

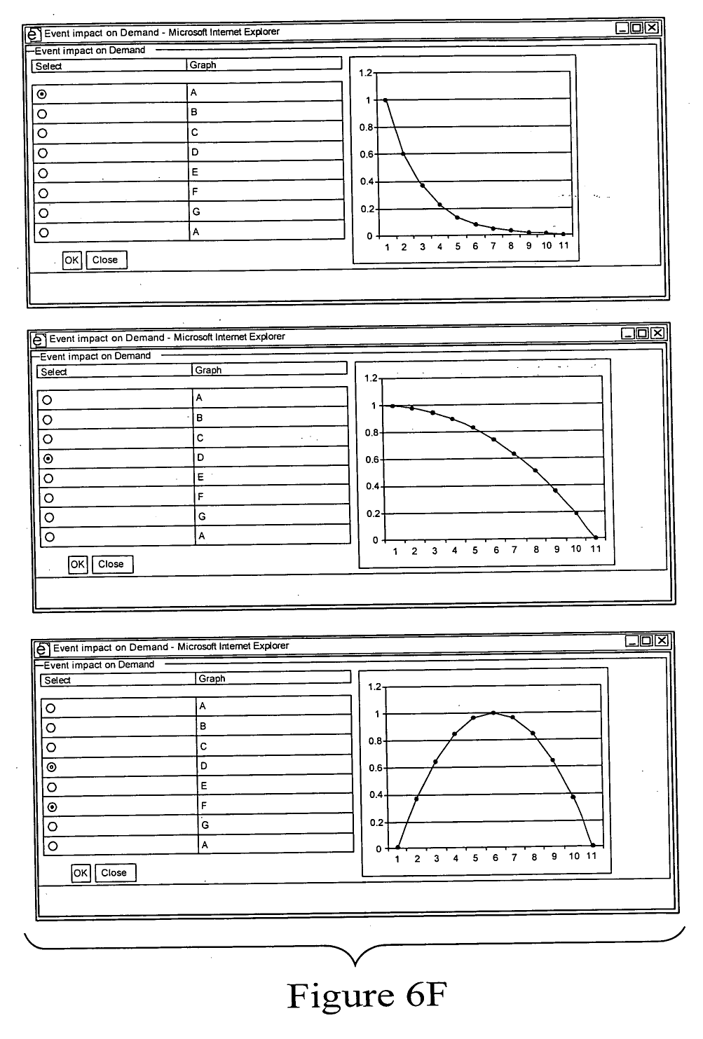

Referring to FIGS. 6A-6E, five types of impact on demand are shown in graphs of the weight of the impact, being stated on the y axis as between 0 and 1, over time, being shown on the x axis between 0 and 1 units of time. For example, in FIG. 6A, the function of impact versus time f(t)=e^{-4.605t}. This is shown in line 146 as the exponentially decreasing impact over time. Similarly, in FIG. 6A, the function f′(t)=1−e^{-4.605t} is shown at line 148. Four further impact functions are shown in FIG. 6B at line 150, and FIG. 6C at lines 152 and 154, FIG. 6D at lines 156 and 158 and FIG. 6E in lines 160 and 162.

Accordingly, with each of the FIGS. 6A-6E showing graphically the impact functions over time, the user is able easily to determine if the default impact is appropriate (as initially can be shown in column 124 using an alphanumeric label therein) and/or whether a more suitable impact profile should be selected. For example, it might be determined that a marketing campaign has the appropriate step function of impact as shown in FIG. 6B for example in the circumstances of a 2 for 1 offer, but in the event of a different type of marketing campaign having a slower start and lesser impact at the end, then impact profile 162 as shown in FIG. 6E might be selected.

Beneficially, the user merely has to select the shape of the impact versus time whereafter the system 12 determines whether or not the primary function f(t) or its inverse f′(t) is selected depending on whether the event has an inflationary or deflationary risk profile (and/or is demand side impact for the scenario as discussed). And moreover, calculates the impact over the selected time for the specific event, that is between the start and end date selected in columns 114 and 116 shown in display panel 90′. As shown in FIG. 6F, graphs from FIGS. 6A, 6D and 6E have been selected for display.

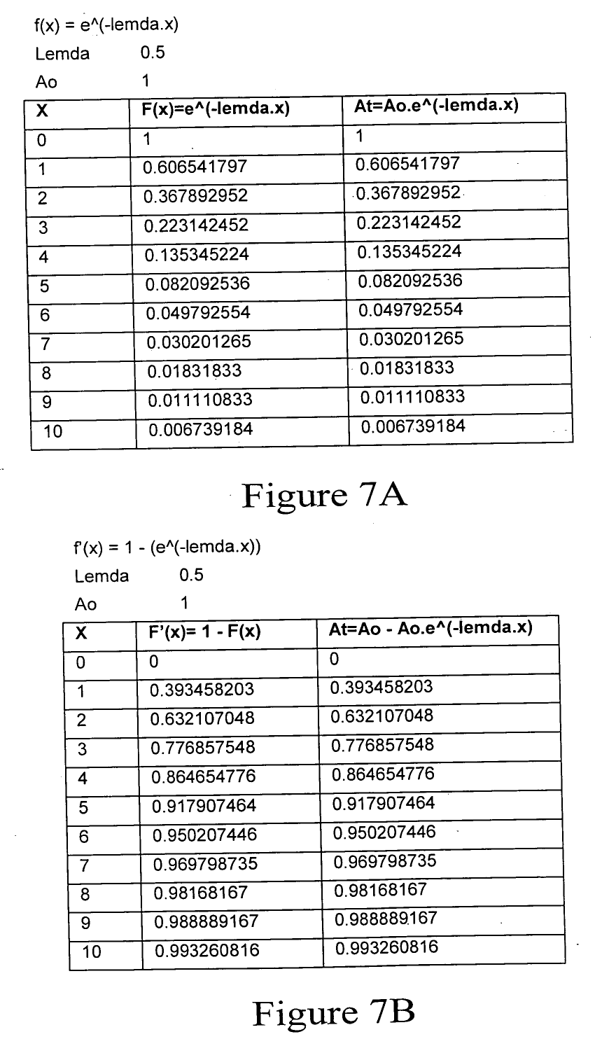

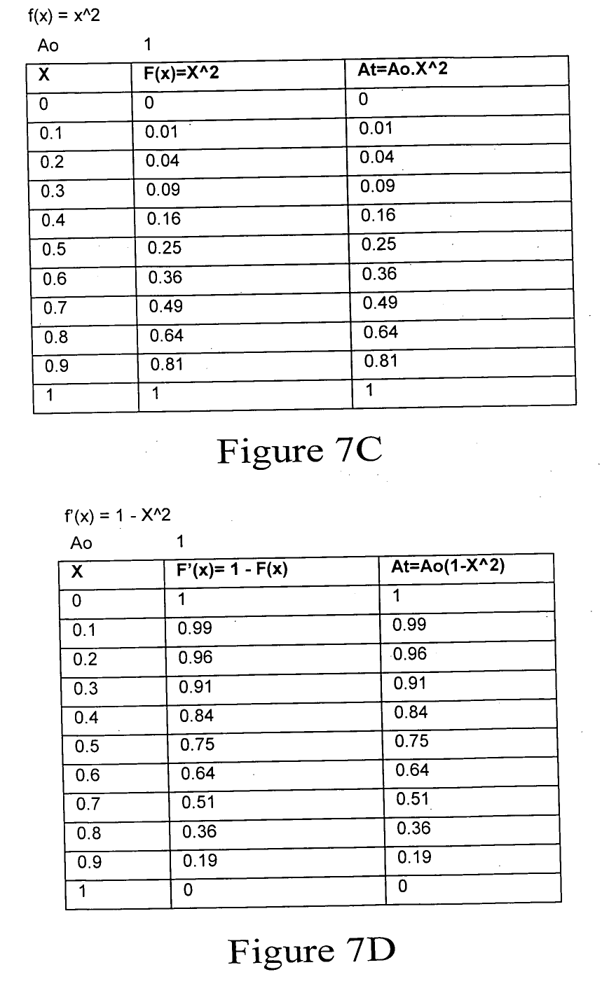

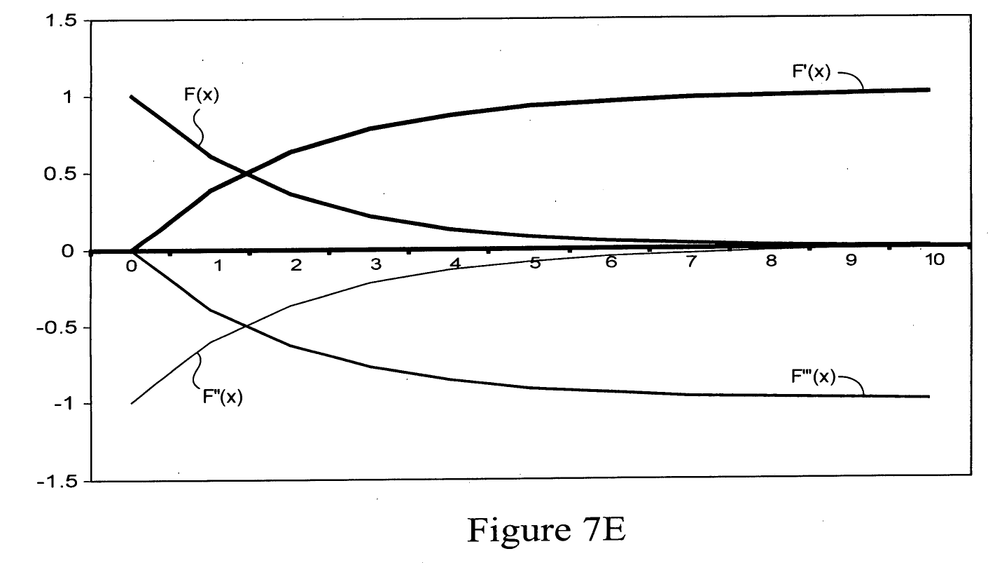

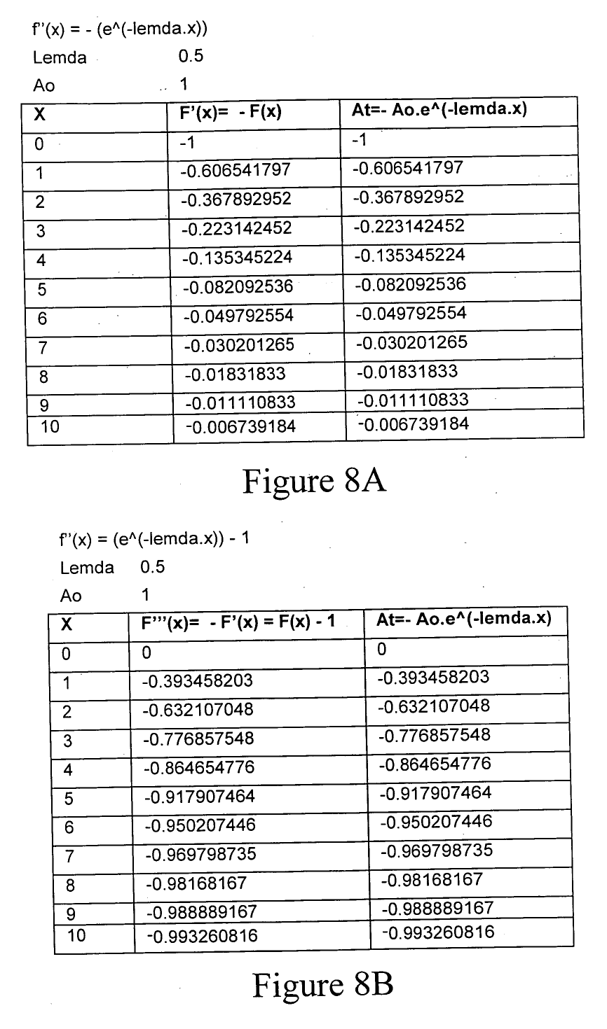

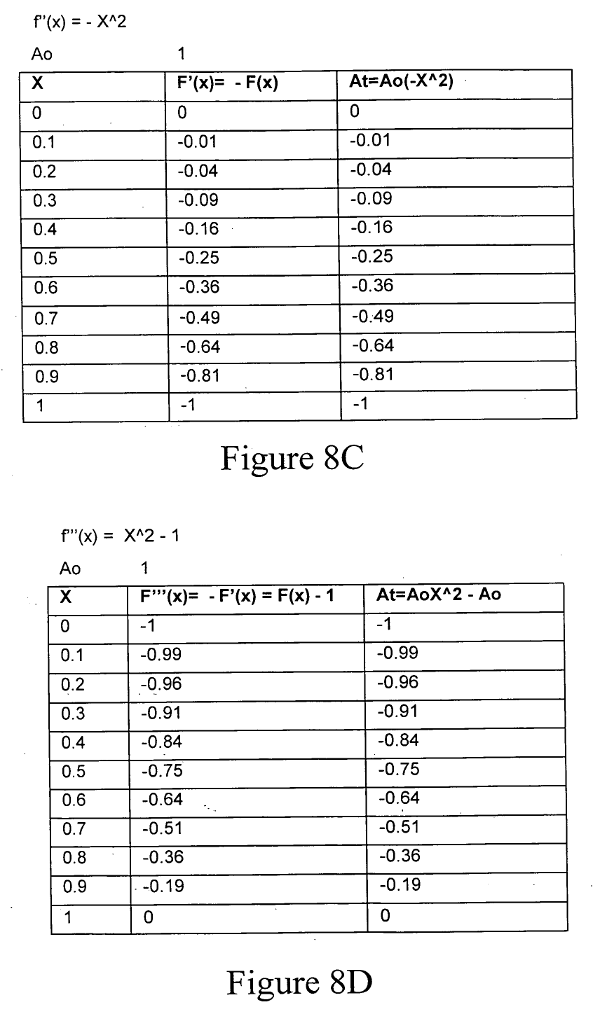

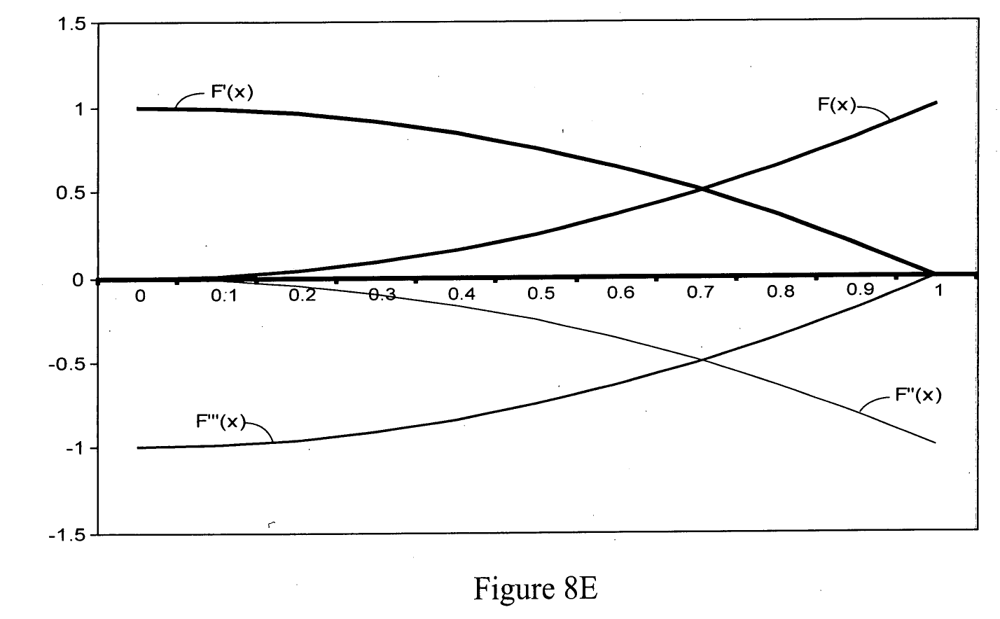

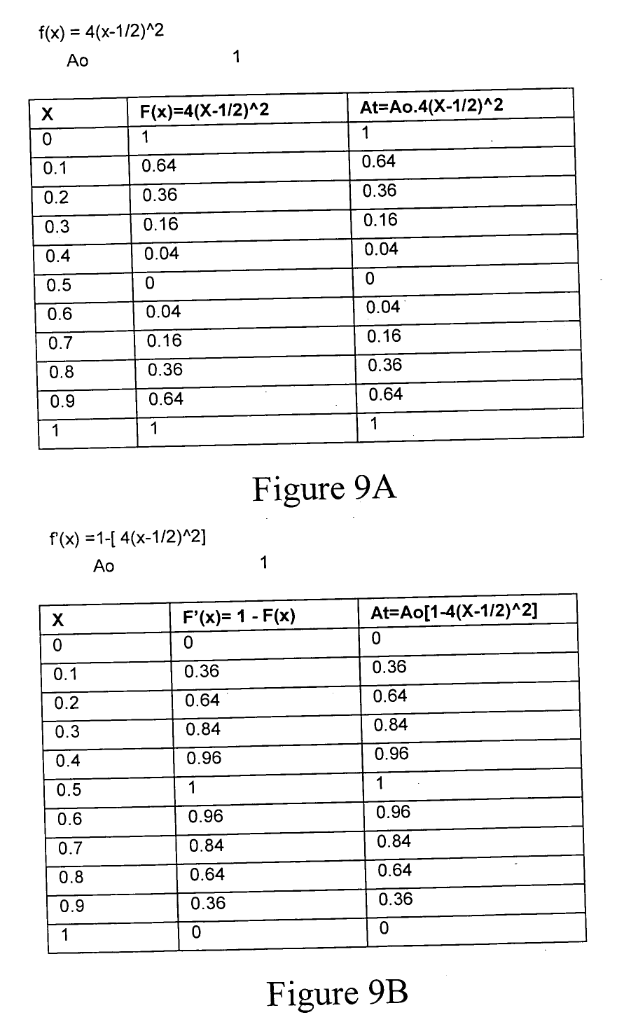

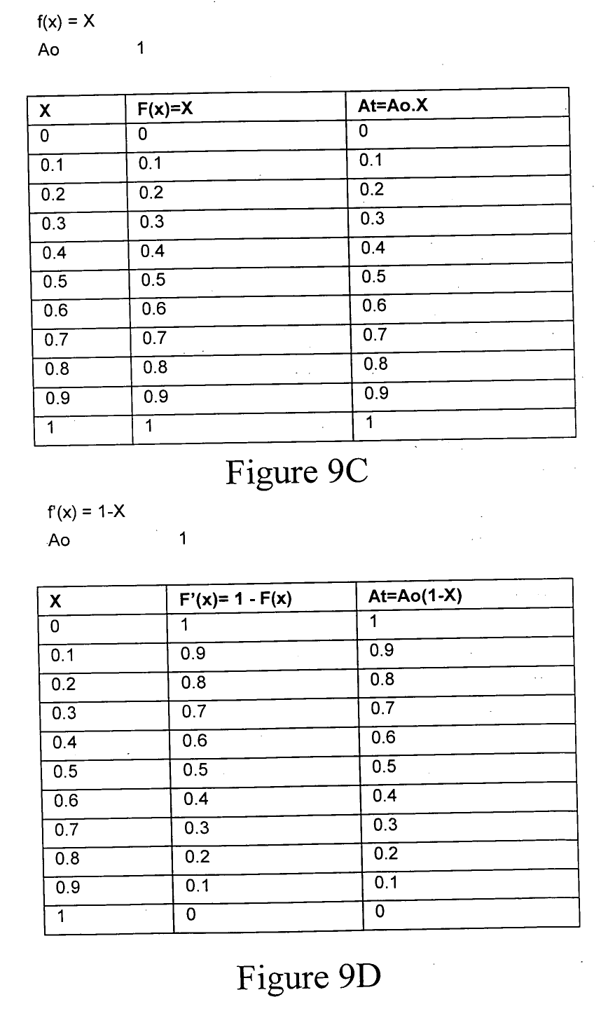

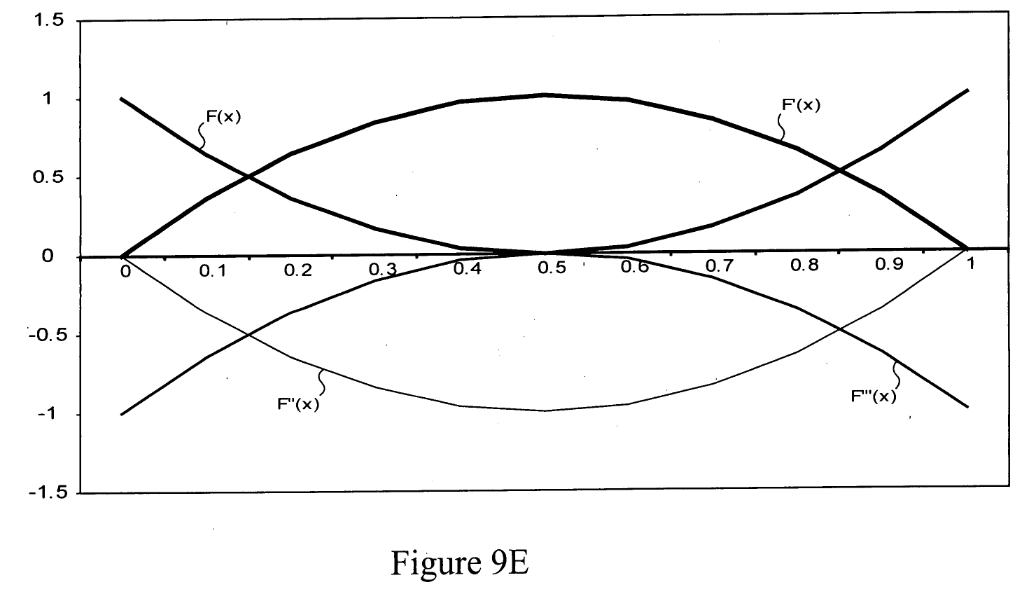

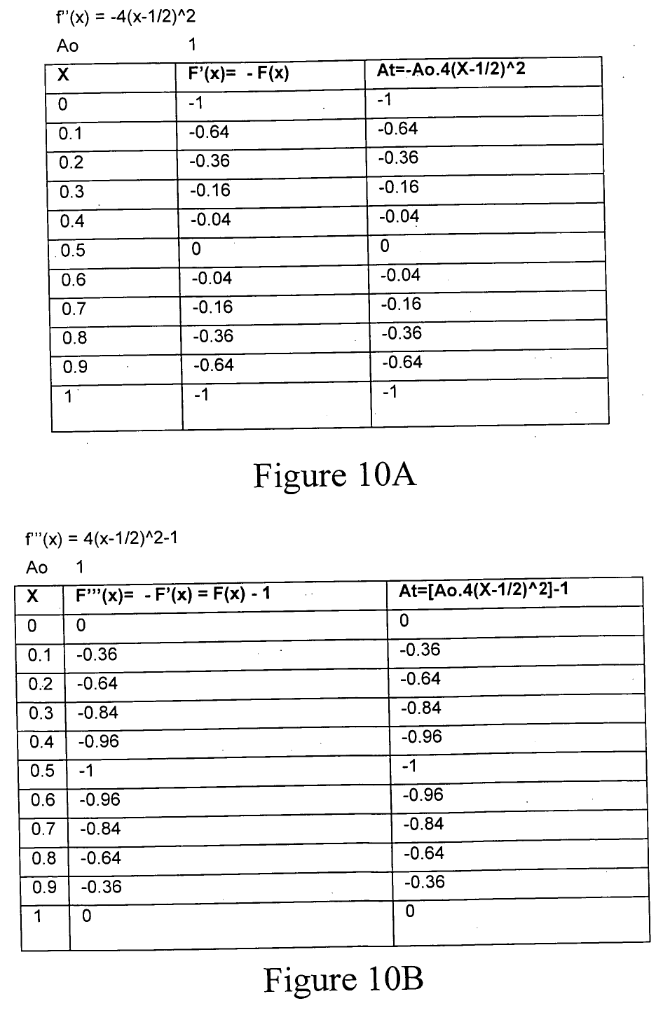

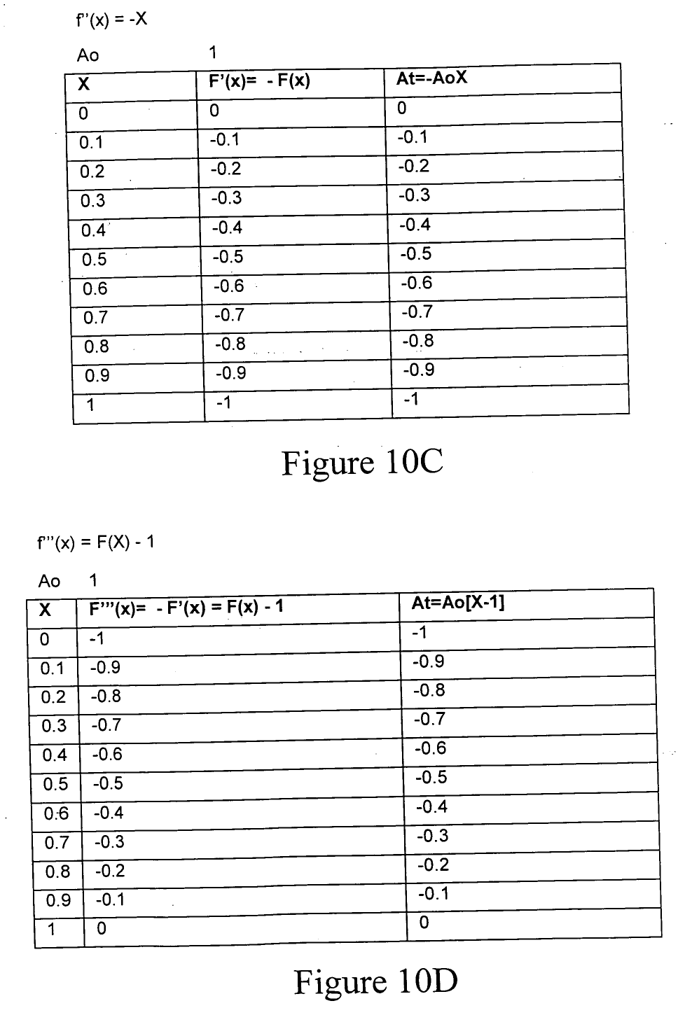

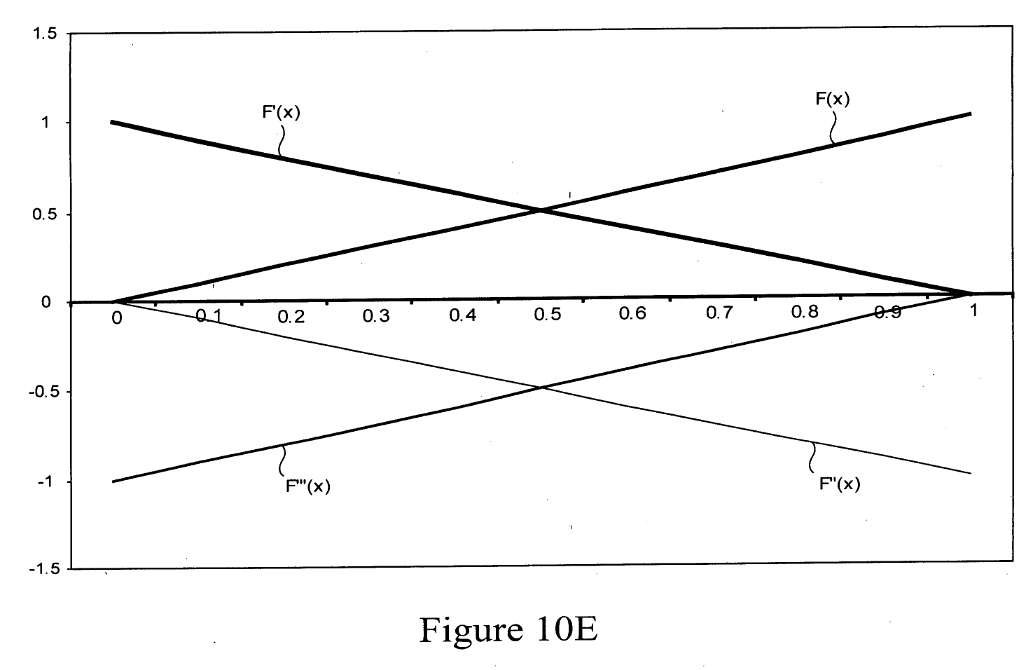

Further types of impact function over time are shown in FIGS. 7A-7E, 8A-8E, 9A-9E and 10A-10E, wherein inflationary and deflationary impact are shown for each function as f(x) and f′(x). Examples of the types of equation are as follows, where F(t) is the impact over time t, A and x are variables:

a F(t)=Ae^{-xt}, F′(t)=1−Ae^{-xt}

b F(t)=1, F′(t)=−1

c F(t)=t, F′(t)=1−t

d F(t)=At², F′(t)=A(1−t²)

e F(t)=1/4(t−1/2)², F′(t)=1−1/4(t−1/2)²

f F(t)=4(t−1/2)^{2,}F′(f)=1−[4(t−1/2)²]

Based on these characteristics, the local computer system 12 is able to determine the probability of impact and weight of impact of an event over time as set out below.

### Example Calculation

Event Probability—Certainly (i.e. 1.0)

Event Type—Inflationary

Impact Weights—High (i.e. 100)

Impact Duration—15 days

Impact Profile—A (exponential decrease Yt=Yo. e^{-kt}) where Yo=Probability×Impact Weight=100

Impact on Day 1=100.e^{-k x (1)}, where K is a decay constant, calculated for decaying of initial impact of 100 to end impact of 1. In this case, value of K is −0.3070 Hence,

Yt₁=100.e−(−0.3070)×(1), where

Yt₂=100.e−(−0.3070)×(2),

Yt₃=100.e−(−0.3070)×(3),

Yt₁₀=100.e−(−0.3070)×(10).

Here an impact value or risk index of 118 is calculated for day 1, 49 for day 2, 8 for day 3 and 1 for day ten using the above equations.

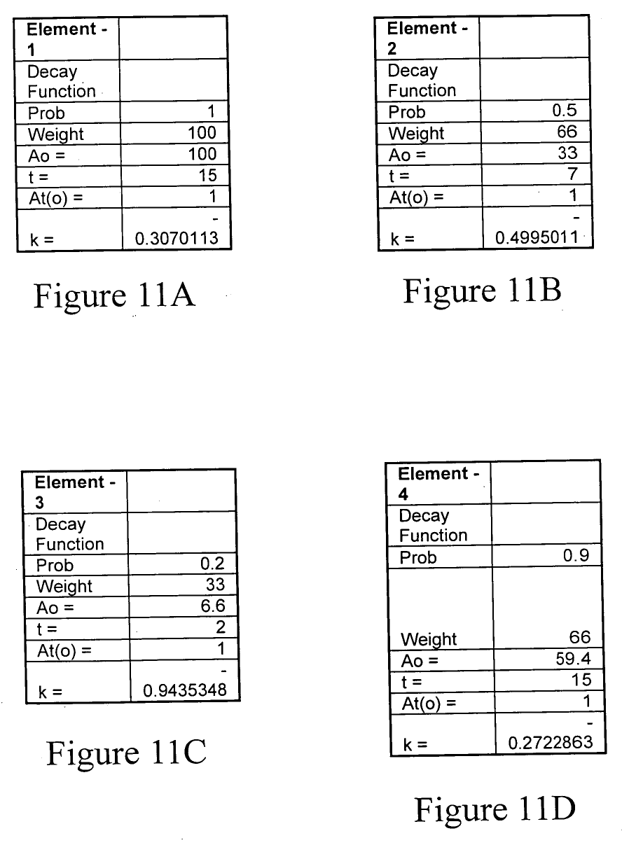

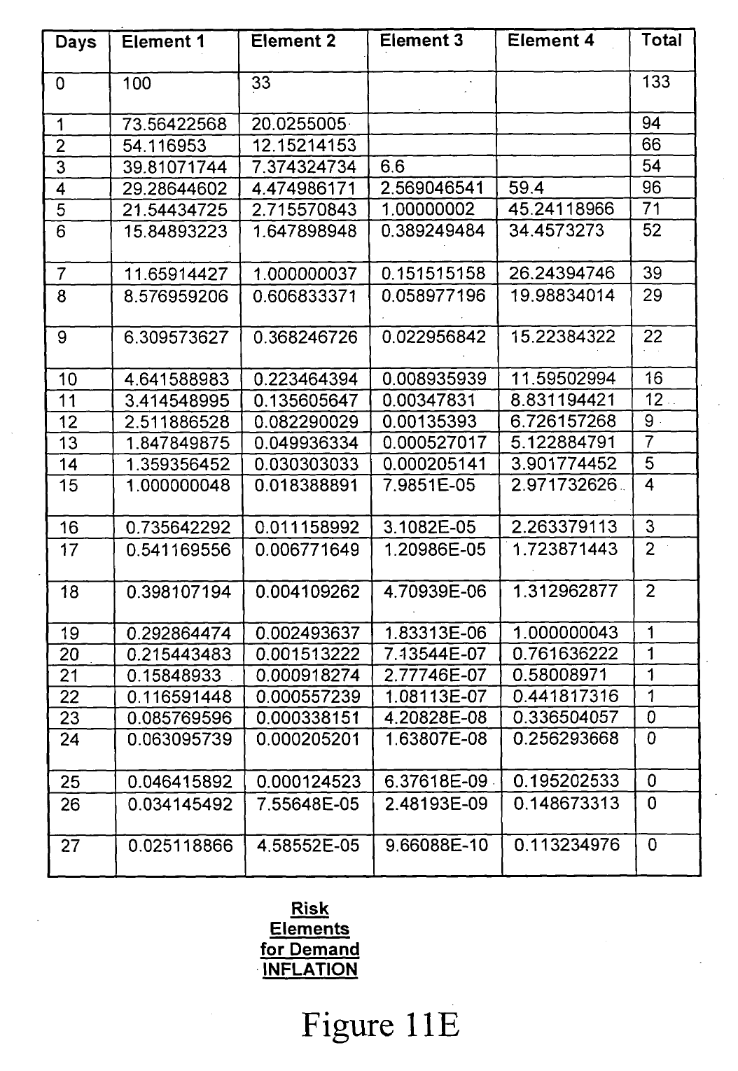

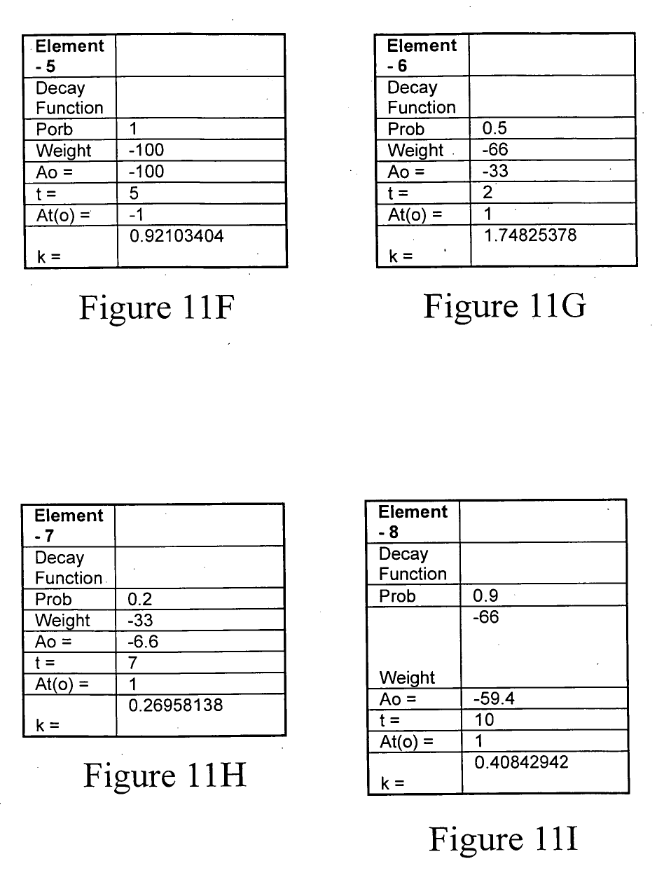

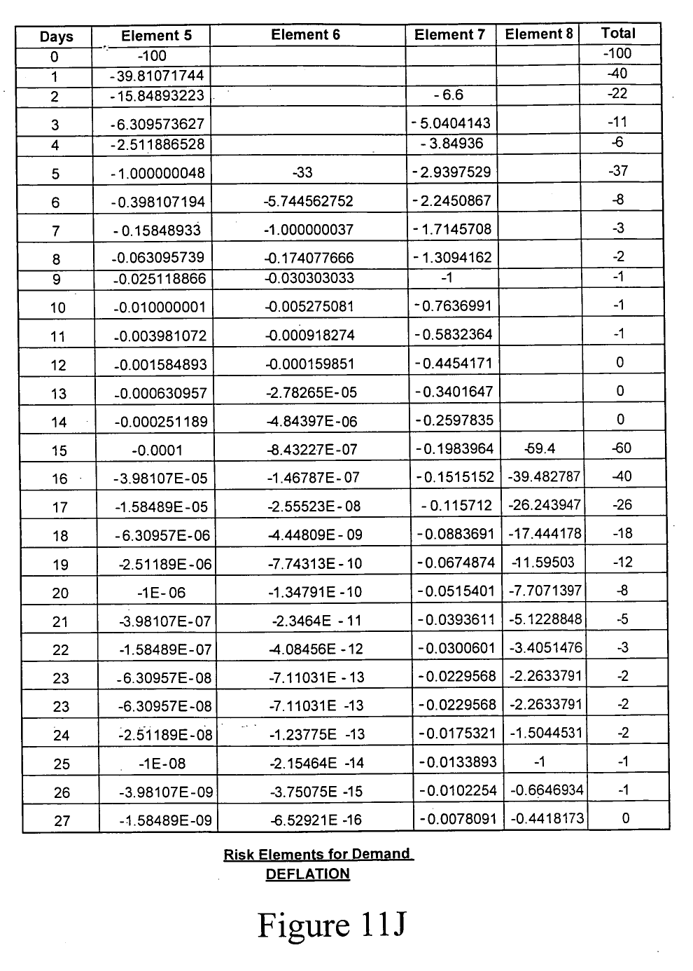

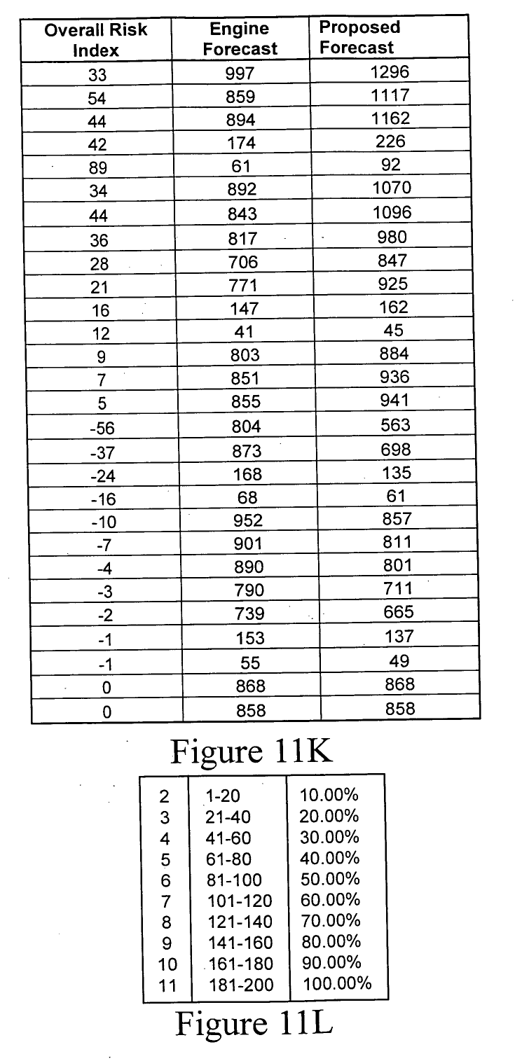

Having built a scenario comprising 8 different events each having defined start end date, probability, impact and risk profile, the system is able to calculate risk elements for each event over the selected time period as shown in FIGS. 11A-11D and 11F-11I. Here a 28 day scenario has been constructed comprising the 8 different events (labeled element 1 to element 8). The function of each of the elements over time is shown in the associated table so element 1 is shown in table a for example. The sum of the risk elements for demand inflation is shown in the table of FIG. 11E for each of the 28 days, day 0 to day 27 (rounded to the nearest integer) as shown in the total column of the table in FIG. 11E. Similarly, the four elements (element 5 to element 8) are shown in the table of FIG. 11J which are risk elements for demand deflation, their total risk element impact on each of the 28 days is again shown in the total column on the right hand side of the table in FIG. 11J.

The overall risk index, being the sum of the total columns in the tables E of FIGS. 11E and 11J, is shown in the first column of the table in FIG. 11K, the engine forecast (or base forecast for example obtainable with the networked system 10 such as from remote server 46; generated by a national user for example) is shown in the central column and the proposed forecast in the final column can be determined.

In one embodiment the proposed forecast in the final column of the table in FIG. 11K is a modification of the engine forecast for the day based on a percentage variation determined by the overall risk index in the first column, such as after conversion or normalization within a predefined scale. The conversion scale is shown in the table of FIG. 11L where an impact index of between 0 and 200 effects a change in the base or engine forecast of between 0 and 100%. The resultant forecast or proposed forecast is shown in the third column of the table in FIG. 11L—e.g. a risk index of 54 equates to a 30% increase, hence demand of 859 on day two converts to 1117 in column 3 of the table in FIG. 11K. Of course the normalization or conversion table can be varied and for example range from 0 to any upper limit such as 400 risk index. The conversion scale can be shown to the user at columns 102 and 104 as shown in panel 90 in FIG. 3.

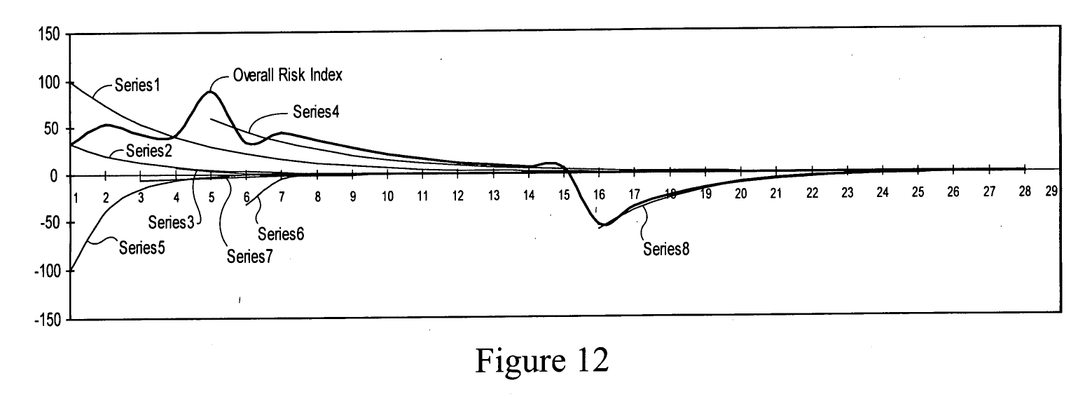

The user is able to view the overall risk index shown in the first column of the table in FIG. 11K graphically as shown in the pop-up display panel 164 shown in FIG. 12. Here each of the elements (labeled series 1, series 2) is shown individually over the 28 day time period together with a sum of all 8 elements (events) which provides the solid line characterizing the likely impact on demand of the scenario of 8 events over the 28 day period. Accordingly, as stated in relation to step 80 in the process 60 shown in FIG. 2, a local manager is able now to consider this scenario in determining any mitigation which might be taken in order to take account of the forecast.

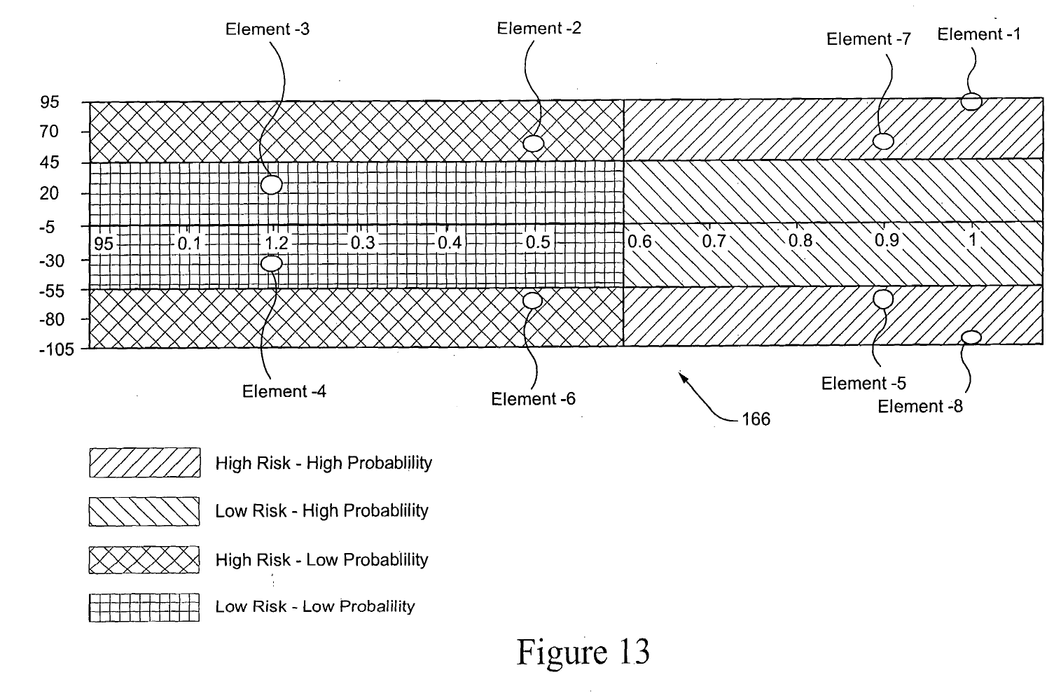

The manager is also able to make use of the risk quadrant which can be displayed as shown in display panel 166 in FIG. 13 wherein each of the elements used in the scenario (as shown in FIGS. 11 and 12) are shown within a risk quadrant having associated risk probability characteristics and beneficially the user is able to interact with the display 18 to determine which events (elements) are likely to have to the greatest impact on the supply chain.

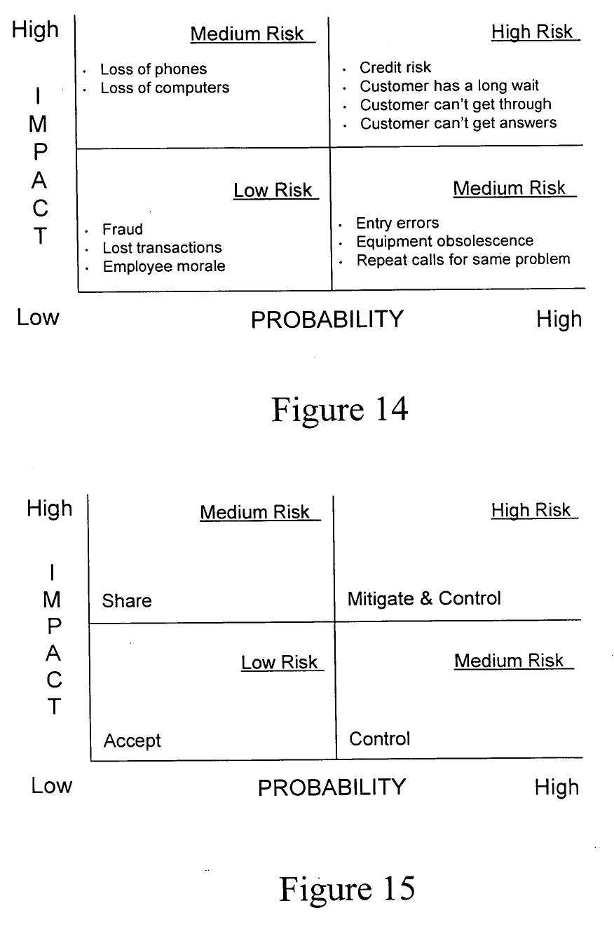

Referring to FIG. 13 there is shown only one element as being of high impact and high probability, namely element 1. System 12 also enables a user to characterize the type of risk from the risk quadrant by reference to some standard risk quadrant information as shown in FIGS. 14 and 15. Accordingly, referring to FIG. 14, a high risk high probability event is characterized as being one of credit risk, consumer has a long wait, customer can't get through and/or customer can't get answers for example in the telephone core centre scenario, and referring to FIG. 15, the user is told to mitigate and control the event. Conversely, in the event of a low risk low probability event, the user is simply told to accept this within the parameters of the scenario.

Finally, the user is able to view the impact of the scenario on a base forecast. Beneficially, a display panel 166 is presented to the user comprising the engine (or base) forecast, the proposed forecast and overall risk index. Hence the user is able to view the overall risk index as shown also in FIG. 12 against the engine forecast and to view how the engine forecast has been modified according to the user's own scenario.

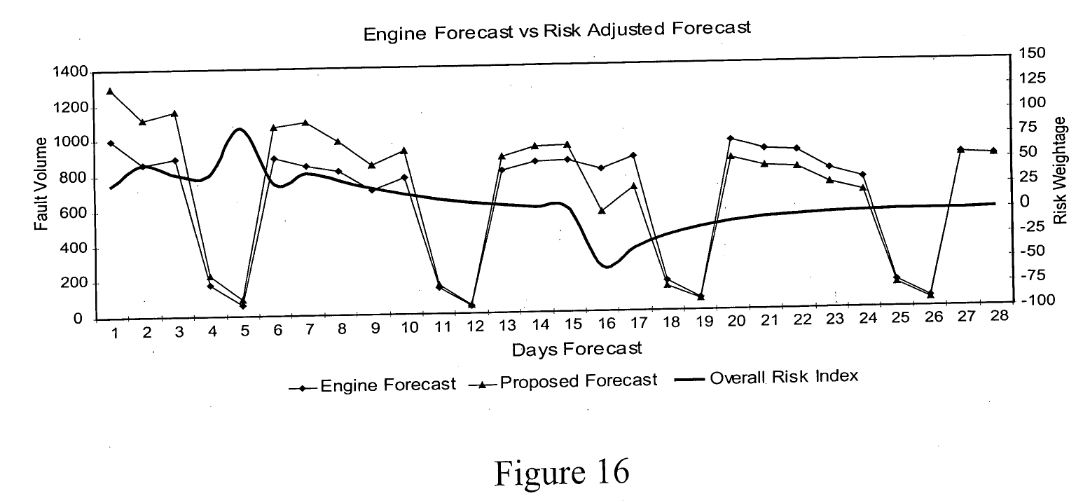

FIG. 16 presents the fault volume on a scale 0 to 1400 on the left hand y axis versus the 28 days of the forecast, and the risk weightage from −100 to 150 on the y axis on the right hand side of the graph.

A Risk Assessment Framework is described below in terms of cataloguing events, scenario building, analysis, and integrating risk index with forecasting as now reiterated.

### Cataloguing

An important factor in the success of effective implementation of Risk Assessment Framework is cataloguing of events. The applicant has designed three categories to classify the events based on their impact:

Demand Side—Events which impacts the demand directly are put into this category. (For example, Heavy Rain, General Demand Decrease/Declining in the market, New Contract Signed, Existing Contract Cancelled, Seasonal Demand Increase, Seasonal Demand Decrease, Promotion, Discount Scheme, Advertising Campaign, Competitor's Price Reduction, New Product Cannibalization, Product Phase Out, Price Reduction etc.)

Supply Side—Events which impacts the supply directly are put into this category. (For example, New Entrants in the market, New contracts increasing the capacity, Temporary Decrease in overall capacity, Raw Material Price increase or decrease, Raw material supply increase or decrease, Logistical Improvements, Logistical Problems etc.)

Shock Events—Events which are sudden and cannot be categorized into above two category, shall be catalogued here. (For example, Company related positive or negative events, Macroeconomic surprises—Positive or negative, R&D News, Regulatory changes, Disasters/Calamities)

Distinction has to be made to include only information which has direct impact on either Demand or Supply. For example, rain could dampen the demand for cement so it should be included in demand category. But legislative change to attract FDI in cement industry will not have direct impact on demand or supply in short term. Competitor's price reduction will have an impact on demand, but its taking over another firm may not have direct impact on demand in short term. Catastrophic events must be put under shock category; which means that whenever this event happens again in future, their impact can be judged. Also, by notifying these events with dates alerts the forecasting engine, not to include those data, or refine them, before using in time-series. It is important to observe here that classification between Demand and Supply side events is not crystal clear always. For example, increase in raw material price can drive the manufacturing cost higher and due to increased price of the finished product, demand is reduced. However, the relationship between raw material price increase and demand reduction is not direct. In this case, raw material price increase is more of a Supply side event then the Demand. Regulatory events are sometimes treated as surprise. However, if their impact can be clearly recognized on either supply or demand side, they should be put into one of them. Above mentioned categorization is illustrative. Idea is to be able to classify events to understand their impact on Demand.

Each of the event should be ascribed with Inflationary (increases the demand) or Deflationary (decreases the demand) impact, further categorized into High, Medium and Low. Quantitative weights to these events remains a business decision. It could be applied with linear weights, or geometrical weights, or any suitable way to numerically capture the difference between high, medium and low impacting events. We will use the scale of 1 to 100 for the same, 100 being the high for Inflationary impact and correspondingly, −100 being high for Deflationary impact. Here, we also define the recurrence of the event, which can feed into Forecasting engine. Please refer to the FIG. 5 for the illustrative categorization and weighing.

### Scenario Building

The cataloguing of events helps users to create and maintain events specific to their particular scenario. The same type of event could, for instance, have different impacts in different areas. In order to capture this, a two step customisation process is proposed. The first step captures the type and the general nature of an event. A typical example is a storm which results in a sudden demand (repair) increase that dies down over time. The user defines the event type “storm” and the general shape of its impact. A library of standard event impact shapes/functions should be provided for simply selection. This library could include many different functions, examples of which are given below.

Without loss of generality, only inflationary functions over [0,1]×[0.1] are given here. The second step sees the creation of a specific event. This is achieved by selecting an event type from step 1 and then specifying the event's actual start and end time, its expected severity/maximum impact, and the likelihood of the event happening. If these parameters are given as tₛ, tₑ, A and p, then a generic impact function ƒ:[0,1]→[0,1] chosen in step 1 can be translated into a specific impact function \tilde{ƒ}: [tₛ, tₑ]→[0, A] for step 2:

$$\tilde{f} ( t ) = A \cdot f ( \frac{1}{{t}_{e} - {t}_{s}} \cdot ( t - {t}_{s} ) ) .$$

This equation has the characteristics that it is defined between the start and end time of the specific event and that the resulting impact values are constrained by the maximum impact. This formula represents the impact of an event without considering the event likelihood. This probability can be considered by including it as a factor:

$$F ( t ) = p \cdot A \cdot f ( \frac{1}{{t}_{e} - {t}_{s}} \cdot ( t - {t}_{s} ) ) .$$

F(t) allows the calculation of the expected impact of a single event over the planning horizon. Once such daily impact values Fᵢ(t) are obtained for all specified events, a cumulative impact for time t can be calculated by

$$RI ( t ) = {\sum }_{i} {F}_{i} ( t ) .$$

This sum defines the Risk Index. FIG. 11 shows one scenario consisting of 8 different events, and the risk index portraying their cumulative impacts.

### Analysis

Another important graph can be prepared here is called Risk Quadrant. There are 4 risk zones and based on impact and probability, each of the event would fall in to one of these four zones.
1. Low Risk—Low Probability
2. Low Risk—High Probability
3. High Risk—Low Probability
4. High Risk—High Probability

The Risk Quadrant helps in applying the appropriate risk mitigation option to each of them. The options are
Accept=Monitor
Avoid=Eliminate (exit out of the situation)
Reduce=Institute Controls
Share=Partner with someone (e.g. Insurance, Hedging)

These options can be correlated with the Risk Quadrant in the manner shown in FIGS. 13, 14 and 15. The same could be explained by the example of a Call Center.

Integrating Risk Index with Forecasting

The Risk Index and cataloguing of events based on their impact and probability prepares organization to apply the right risk mitigation strategy and channelize the hedging effort. If we could integrate Risk Index with the forecast, it could provide users a true picture of variation in base forecast for each simulated scenario. For the given value of Risk Index, how much impact shall be taken to modify the statistical forecast, can be decided by business experience or by solving a small optimization problem to increase MAPE. For example, if the value of Risk Index is between −1 to −5, the statistical forecast will be pulled down by 5% and if SI is between +1 to +5, the statistical forecast will be pulled dup by 5%. Variation in these weights would allow to modify, and not replace, the base forecast. However, for the large value of Risk Index, modification in forecast could be as large as 100%.

The process maintains the essence of carrying out statistical forecast through complex forecasting models, and bootstrapping the experience of business users in understanding future events and their impacts. The former is retrospective while the later is prospective. The right combination of the two helps forecasters in making consistent decisions in planning. Below is one of such simulated scenario. The graph shows actual volume against both, statistical forecast and proposed forecast using Risk Index. The graph shows the improvement in Forecast direction and MAPE by 7%. The mean value of adjusted forecast is also much closer to the actual mean.

The framework is flexible to adopt different requirements of different business and geographies. While its flexibility and ability to capture and apply human experience is a strength, that is also its weakness too. Defining weightages to the event impacts and integrating Risk Index with the statistical forecast, are two important areas and requires users to try few combinations before reaching the right one. Sensitivity analysis of events on the forecast could come very handy, if such history is available.

Although the present invention has been described in connection with various exemplary embodiments, those of ordinary skill in the art will understand that many modifications can be made thereto within the spirit of the invention and the scope of the claims that follow. Accordingly, it is not intended that the scope of the invention in any way be limited by the above description, but instead be determined by reference to the claims that follow.

What is claimed is:

1. A supply chain forecasting system enabling integrated risk assessment and forecasting of the impact of events on a supply chain comprising a processor adapted to receive, process and output data for a forecast, and a user interface adapted to enable a user to input parameters to facilitate processing of a forecast, wherein the user interface provides a user the ability to select an event which is likely to have an impact on a supply chain and to view a visual representation of different types of impact over time of an event thereby enabling a user readily to understand the nature of the impact of an event on a supply chain and hence to select the most appropriate type of impact over time for an event.

2. A system according to claim 1 wherein a range of different types of impact profiles for an event are selectable by a user and at least one of: the range is definable by at least one level of user; and the range is configurable for a given geographical location.

3. A system according to claim 1 wherein the impact profile is defined according to one of the following equations, where F(t) is the impact over time t, A and x are variables:
a F(t)=Ae^{-xt}, F′(t)=1−Ae^{-xt}
b F(t)=1, F′(t)=−1
c F(t)=t, F′(t)=1−t
d F(t)=At², F′(t)=A(1−t²)
e F(t)=1/4(t−1/2)², F′(t)=1−1/4(t−1/2)²
f F(t)=4(t−1/2)^{2,}F′(f)=1−[4(t−1/2)²]

4. A system according to claim 1 wherein the visual representation of the impact over time is standardised and the system is configured automatically to adapt a selected impact profile according to other impact and event parameters within a forecast.

5. A system according to claim 1 comprising a catalogue of pre-defined events having associated default settings for at least one of risk profile, impact, probability, and impact versus time characteristics.

6. A supply chain forecasting system enabling integrated risk assessment and forecasting of impact of events on a supply chain comprising a processor adapted to receive process and output data for a forecast and a user interface adapted to enable a user to input parameters to facilitate processing of a forecast, the system comprising a catalogue of pre-defined events which might be influential in the forecast, each event having associated settings for at least one of risk profile, impact, probability, and impact versus time characteristics.

7. A system according to claim 6 wherein the user is able to create a forecast scenario based on a number of events, and the user interface enables the user to filter the selection of events held in the catalogue using at least one filter parameter thereby to reduce the number of events which might be influential in a forecast scenario.

8. A system according to claim 7 wherein the filter parameter is selectable from at least one of geographical area, nature of the supply chain, type of goods, type of service, and type of event including at least one of demand influencing, supply influencing and shock event.

9. A system according to claim 6 wherein the user interface enables a user to select and modify the settings for an event.

10. A system according to claim 6 wherein the user interface enables a user separately to select events according to their likelihood of impact on one of the demand and the supply side of a supply chain and preferably wherein the system is configured automatically to determine the positive or negative influence of the selected event in a forecast model and more preferably a visual representation of the impact of the event within the forecast model.

11. A supply chain forecasting system enabling integrated risk assessment and forecasting of impact of events on a supply chain comprising a processor adapted to receive process and output data for a forecast and a user interface adapted to enable a user to input parameters to facilitate processing of a forecast, the system being adapted to provide a user interface which enables a user separately to select events according to their likelihood of impact on one of the demand side and the supply side of a supply chain.

12. A system according to claim 11 wherein the user interface presents the demand side and supply side events in different display panels to the user.

13. A system according to claim 11 adapted automatically to determine the positive or negative influence in the supply chain of the selected event in a forecast model according to whether it is a demand or supply side influencing event.

14. A system according to claim 1 wherein the period of an event is selectable by a user by defining at least two of the start, end and duration of the event, the system being adapted automatically to determine a third of these variables.

15. A system according to claim 14 adapted automatically to determine the impact for an event over the appropriate period of time according to the event start, end and duration.

16. A system according to claim 1 enabling a user to select the nature of an event as being one of inflationary and deflationary on the supply chain.

17. A system according to claim 1 enabling a user to adjust the level of impact of an event according to a predefined range of levels of impacts expressed in common terms such as high, medium and low.

18. A system according to claim 17 wherein the level of impact associated with selectable levels has an associated percentage value.

19. A system according to claim 1 wherein the user is able to select the probability of occurrence of an event based on a finite range of selectable probabilities expressed in easily understandable terms.

20. A system according to claim 19 wherein the terms include at least one of certainly, almost certain, fairly certain, maybe, maybe maybe not, unlikely, and bleak possibility.

21. A system according to claim 19 wherein the selectable probabilities have associated therewith predetermined percentages.

22. A system according to claim 1 wherein the user is able to select the re-occurrence and hence frequency of occurrence of an event.

23. A system according to claim 1 adapted to sum of the impact on demand on a supply chain of two or more events defined by a user thereby to present the user with a combined risk assessment forecast of events on a supply chain.

24. A system according to claim 23 adapted to adjust a base forecast for a given period based on the user input of event parameters through the user interface

25. A system according to claim 1 adapted to provide a visual representation to the user of a supply chain according to the impact of selected events in a user created scenario

26. A system according to claim 25 wherein the visual representation comprises a graphical representation of impact over time.

27. A system according to claim 25 wherein adapted to provide the user with a risk quadrant display of selected events in a scenario.

28. A method of using a computer system to provide an integrated risk assessment and forecast of the impact of events on a supply chain comprising the steps of enabling a user to select an event which is likely to have an impact on an aspect of a supply chain, to view a visual representation of different types of impact over time of an event thereby enabling a user readily to understand the nature of the impact of an event on a supply chain and hence to select the most appropriate type of impact over time for a given event, and forecast the affect of the event on the supply chain at least in part based on the nature of the impact of the event selected by the user.

29. A computer program product comprising instructional data which when operated on by a computer enables the computer to perform the method of claim 28.

30. A user interface comprising a visual display enabling a user to interact with a computer system to provide integrated risk assessment and forecasting of the impact of events on a supply chain, wherein the user interface is adapted to enable a user to select an event which is likely to have an impact on an aspect of a supply chain based on a visual representation of different types of impact over time of events displayable within the visual display thereby enabling a user readily to understand the nature of the impact of an event on a supply chain and hence to select the most appropriate type of impact over time for an event.

31. A method of using a computer system to provide an integrated risk assessment and forecast of the impact of events on a supply chain comprising the steps of providing a user with a catalogue of pre-defined events which might be influential in the forecast, each event having associated settings for at least one of risk profile, impact, probability, and impact versus time characteristics.

32. A method according to claim 31 further comprising the step of enabling a user to create a forecast scenario having a number of events, enabling the user to filter the range of events held in the catalogue according to at least one filter parameter thereby to reduce the number of events selectable for the scenario.

33. A method according to claim 31 comprising the step of enabling the user to select the filter parameter from one of geographical area, nature of the supply chain, type of goods, type of service, and type of event including at least one of demand influencing, supply influencing and shock event.

34. A computer program product comprising instructional data which when operated on by a computer enables the computer to perform the method of claim 31.

35. A user interface comprising a visual display enabling a user to interact with a computer system to provide integrated risk assessment and forecasting of the impact of events on a supply chain, wherein the user interface is adapted to provide a user with a visual representation of a catalogue of pre-defined and selectable events which might be influential in the forecast, each event having an associated setting for at least one of risk profile, impact, probability, and impact versus time characteristics.

36. A supply chain forecasting system enabling integrated risk assessment and forecasting of the impact of events on a supply chain comprising a processor adapted to receive, process and output data for a forecast, and a user interface adapted to enable a user to input parameters to facilitate processing of a forecast, wherein the user interface provides a user the ability to select an events which is likely to have an impact on an aspect of a supply chain and to create a scenario comprising a number of such events wherein the processor is adapted to combine the effects of the events selected for a scenario in order to determine an overall impact of the events in a forecast, the combination of impacts being weighted according to a predetermined conversion of the sum of the impact values (risk indices) for the individual events.

37. A method of providing an integrated risk assessment and forecast of the impact of events on a supply chain comprising the steps of cataloguing events having a potential impact on a supply chain, enabling a user to build a scenario of selected events, analysing the risk and impact of the events in the scenario, and integrating risk over time of the events to provide a forecast of the behaviour of the supply chain in the scenario.
